(19) United States
(12) Patent Application Publication
(10) Pub. No.: US 2010/0202824 A1
(43) Pub. Date: Aug. 12, 2010

(54) CONNECTOR FOR CONNECTING TWO HOLLOW SECTION-PIECE ENDS

(75) Inventor: Renaud Subra, Metz (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain Glass France, Courbevoie (FR)

(21) Appl. No.: 12/676,992

(22) PCT Filed: Oct. 3, 2007
(86) PCT No.: PCT/FR07/52069

§ 371 Date: Mar. 8, 2010

(51) Int. Cl. F16B 1/00

(52) U.S. Cl. 403/42

(57) ABSTRACT

Connector (1) intended to connect two hollow section-piece ends, comprising a body (10) and a sealing element (3) which is impervious to liquids, gases and water vapor and which is supported by a part (11) of the body (10), characterized in that the sealing element (3) comprises two opposed protrusions (31, 32) which project laterally with respect to the sealing element support part (11) so as to form, between these protrusions and the body (10) respectively two accommodating spaces (40, 41).

The invention relates to a connector for connecting two hollow section-piece ends in order to form for example a frame that constitutes the spacer of an insulating glazing unit. The connector comprises a body and a sealing element sealed against gases and water vapor and arranged as a secure attachment to part of the body.

The invention will be described more especially with reference to an application to a glazing unit without, however, being restricted thereto, and may be applied to other non-glassmaking applications.

One well-known type of insulating glazing unit comprises two sheets of glass spaced apart by a layer of gas such as air and which are kept apart and held together by a spacer frame consisting of hollow metal section pieces which are bent into shape or of section pieces which are assembled by central and/or corner pieces known as connectors. The section pieces are covered with a molecular sieve which has the role of absorbing any water molecules trapped in the air interlayer at the time of manufacture of the glazing unit or which are liable to infiltrate into the glazing unit during the life thereof (an insulating glazing unit is never perfectly sealed) and which would be liable to condense in cold weather, leading to misting.

In order to seal the glazing unit, the spacer frame is bonded to the sheets of glass with a bead of elastomer of butyl rubber type applied directly to the section pieces that form the spacer frame by extrusion through a nozzle.

Once the glazing unit has been assembled, the bead of sealing elastomer acts to temporarily hold the sheets of glass mechanically. Finally, a crosslinkable sealing mastic of the polysulfide, polyurethane or silicone type is injected into the peripheral groove delimited by the two sheets of glass and the spacer frame thus completing the mechanical assembly of the sheets of glass. The chief purpose of the butyl rubber is to seal the inside of the glazing unit against water vapor, while the mastic provides sealing against liquid water or against solvents.

Known by way of a connector for insulating glazing unit spacer section pieces is for example the connector described in patent application EP 0 283 689. This connector is forcibly inserted into the hollow section-piece ends and held firmly by lateral retaining projections which are directed in the direction opposite to the direction in which the section-piece ends would have to be pulled if they were to be disassembled.

Once the two section-piece ends have been butted together, there is unavoidably, at the joint, a tiny space which has to be sealed against gases. A sealing gasket of butyl type as already explained above, or alternatively some more mastic, is generally added at this joint and to the faces of the interlayer which will face the layer of gas.

In patent application US 2003/0059253, the sealing of the joint between the two section-piece ends is made using a sealing material which is not added to the outside of the section-piece ends after these have been butted together, but which is deposited inside the two hollow section-piece ends, more specifically arranged in a cavity made in the body of the connector at the joint. This is a material which is injected into the cavity of the connector after one of the section-piece ends has been connected and which flows to the appropriate positions to form the seal, the second end then being attached against the first.

Those documents describe substantially flat connectors for butting section pieces together along one side of the frame in a lengthwise joint. The connecting principle is similar for the corner connections of a frame, when the frame is not made of a section piece that is bent into shape at the corners. The rectangular frame is actually made up of longitudinal section pieces which are connected at the corners using corner connectors, sealing being achieved by adding butyl.

However, these various methods for sealing the joint between two section-piece ends in a lengthwise joint or corner joint lead, in the manufacture of the frame, to an additional operation of depositing sealant, thus entailing the addition of material and special-purpose tooling for performing this operation.

Furthermore, if, on certain production lines, the sealing operation is performed after the operation of connecting the section-piece ends (particularly when the material is added after the ends have been butted together), it is necessary, through suitable means, particularly when making lengthwise joints, to determine the precise position of the joint or joints so that the material can be added at the correct location.

Hence, an operation such as this makes no contribution toward saving on manufacturing costs and improving production rates.

Now, it is always desirable in a manufacturing process to reduce the number of steps needed and/or to simplify them, and to minimize manufacturing costs.

Patent application WO 05/106177 proposes a novel solution and describes a connector of which the body, in its central part and on one of its faces, is directly provided with means for sealing against gases and against water vapor. These sealing means have a suitable shape, or are associated, on the opposite face of the body of the connector, with a system for compressing said sealing means so that as the connector is inserted into the hollow ends of two section pieces that are to be butted together, one of the interior walls of the section pieces is thrust against the face of the connector opposite to the one equipped with the sealing means, thus compressing the sealing means against the opposite interior wall of the section pieces.

The solution recommended in that document makes it possible, by directly providing the connector with the sealing means, to simplify the operation of connecting two section pieces.

The aim of the invention is therefore to provide a connector that also incorporates sealing means, but in a different embodiment, so that two section-piece ends can be connected in a sealed manner in either a lengthwise or corner joint.

Thus, the sealing means are intrinsic to the connector. Once the connection has been made, the sealing is also ensured. No additional sealing operation has to be performed.

According to the invention, the connector comprises a body and a sealing element which is impervious to liquids, gases and water vapor and which is supported by a part of the body, the sealing element comprising two opposed protrusions which project laterally with respect to the sealing element support part so as to form, between these protrusions and the body respectively two accommodating spaces, and is characterized in that the protrusions of the sealing element have respective ends which are inclined in the same direction, particularly curved toward the body of the connector.

The body of the connector and the sealing element are made of two separate materials or of the same material.

According to one feature, the protrusions are made of an elastic material.

According to another feature, the sealing element is made of a plastic material with a hardness ranging between 20 and 60 Shore A, such as an elastomer, for example of the styrene-ethylene-butylene-styrene (SEBS) type, or a thermoplastic such as an injectable polyurethane, or alternatively an EPDM.

Because of the sealing to be imparted to the device with which the connector will be associated, the sealing element covers at least one face of the part of the connector and preferably falls onto an edge portion of the lateral faces of said part of the connector.

The height of the sealing element does not exceed 1 mm, and is preferably of the order of 0.5 mm. Indeed, as will be seen later, the connector, once associated with the section pieces to form a frame, has the sealing element projecting from the external face of the section pieces such that the external face of the frame obtained is not at the same level over its entire periphery. Now, it is preferable for this difference in level not to be too great in order to guarantee a good result with regard to the automated step of applying butyl to the lateral walls of the section pieces with a view to bonding the frame to the sheets of glass. The extruder or extruders are programmed to apply the bead of butyl to the section pieces of the frame at a certain height with respect to the conveyor on which the frame is resting; a difference in level therefore offsets the height at which the bead is deposited by a corresponding amount, leading to the risk that not enough butyl will be applied in the right place to bond the frame adequately to the sheets of glass.

Depending on the use of the connector, the body may, for example, be essentially longitudinal, in order to make a lengthwise joint, and in particular comprises two wings one extending on each side of the support part, these being connected to two opposite faces of said part over part of its height and some distance from the edges of the faces, the wings facing the protrusions of the sealing element.

In another embodiment, in order to make a corner connection, the body comprises two wings one extending on each side of the support part at angles, generally at right angles, these being connected to two opposite faces of said support part over part of its height and some distance from the edges of the faces, the wings facing the protrusions of the sealing element.

The sealing element support part has a minimized width, particularly one less than 3 mm, and preferably of the order of 1 mm, in order to optimize the additional length resulting from the connection when two section pieces are butted together using the connector. The section pieces actually butt against this support part as we will see later, whereas most of the connectors have their entire body inserted into the hollow part of the section pieces. Hence, care will be taken to adapt the length of the section pieces accordingly in order to achieve the desired side lengths for the frame that is to be obtained.

According to another feature, the body of the connector is made as a single piece and in particular is based on a plastic material but could also as well be made of metal.

The body of the connector, just like the sealing element, may be obtained by molding.

There are various conceivable ways of securing the sealing element to the body of the connector, such as by clip-fastening, bonding, welding, overmolding.

However, the body and the sealing element may just as readily be obtained in a single process, such as a molding using a two-shot injection molding technique.

Finally, when the body of the connector has wings, these advantageously have, projecting from their lateral walls, a retaining system, such as a metal or plastic pin passing right through the wing. This retaining system means that the connector has to be forcibly inserted into the device for which it is intended in order to be held in position and prevent its untimely removal.

Thus, the connector of the invention makes it possible to form an assembly formed of at least two hollow section-piece ends and of at least one connector connecting said section-piece ends, each of the accommodating spaces of the connector housing the wall of a respective section-piece end, and the sealing element having its lateral protrusions pressed against the external face of each of said walls of the section-piece ends thereby exerting a preload via the inclined ends of said protrusions, the two hollow ends collaborating with the body of the connector and coming in abutment against two of the opposite faces of the sealing element support part respectively.

Thus, the sealing which is achieved by the material constituting the external or exterior face of the section piece intended to face toward the exterior environment is rendered continuous at the joint between two section-piece ends, by virtue of the sealing element which snuggly covers the exterior face of the section-piece ends.

Via its lateral protrusions, the sealing element also tolerates any play there might be in the positioning of the section-piece ends in abutment against the part of the connector, without disrupting the continuity of the seal.

Furthermore, the lateral protrusions of the sealing element preferably drop onto an edge portion of the external face of the lateral walls of the section-piece ends, so as to further enhance the sealing of the connection between the section pieces at their exterior face.

In one exemplary embodiment, the body of the connector is provided with two wings extending respectively from two opposite faces of the sealing element support part, the two wings being respectively inserted into the two hollow section-piece ends. The connector is therefore kept immobilized in the hollow section-piece ends by virtue of retaining systems present on the lateral walls of the wings.

An assembly such as this of at least one connector with two section-piece(s) ends in particular makes it possible to produce a frame, for example to be used in an insulating glazing unit, the sealing element ensuring the continuity of the seal at the joint with the hollow section-piece ends, the face of the section piece or section pieces that form(s) the frame is covered at the section-piece ends with the protrusions of the sealing element being sealed against liquids, gases and water vapor.

In order to connect two hollow section-piece ends using a connector according to the invention, the connector is forcibly inserted, via one of its wings, into the hollow part of one of the section-piece ends, while the second section-piece end is fitted around the free opposite wing of the connector, also by establishing a pushing force until the two section-piece ends butt against the sealing element support part, the sealing element covering the joint between the section-piece ends, at least on the face intended to face the external environment, with a preload exerted by the inclined ends of the protrusions of the sealing element.

Further advantages and features of the invention will now be described in greater detail with reference to the attached drawings in which:

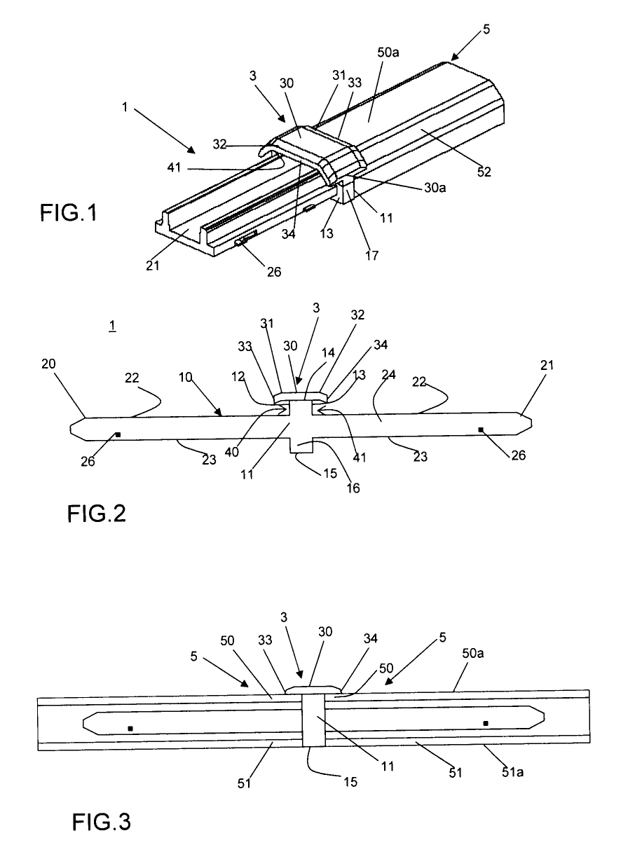

FIG. 1 is a profile view of the connector of the invention intended for a lengthwise joint, part of the connector being connected to the hollow end of a section piece;

FIG. 2 is a schematic sectioned view of the flat connector of FIG. 1;

FIG. 3 is a schematic sectioned view of the connection of two section-piece ends using the flat connector of FIG. 2;

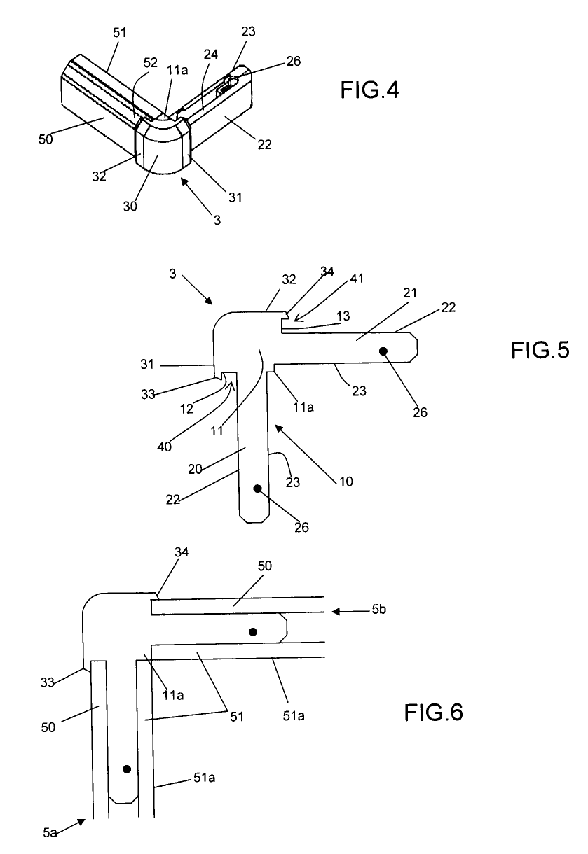

FIG. 4 is a profile view of the connector of the invention intended for a corner joint, part of the connector being connected to the hollow end of a section piece;

FIG. 5 is a schematic sectioned view from above of the corner connector of FIG. 4;

FIG. 6 is a schematic sectioned view from above of the connection of two section-piece ends using the corner connector of FIG. 5;

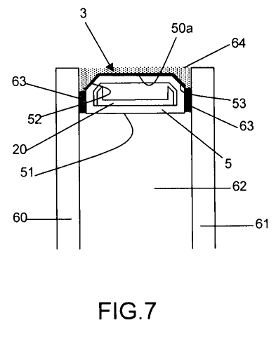

FIG. 7 is a schematic part view in section of an insulating glazing unit the frame of which is provided with a connector according to the invention.

FIGS. 1 and 2 illustrate a flat connector 1 of the invention intended for the sealed connection of two section-piece hollow ends 5 in a lengthwise joint as visible in FIG. 3.

The connector 1 comprises a body 10 which may be made of a first material and a sealing element 3 which may be made of a second material and associated with the body 10.

The body 10 of the flat connector extends longitudinally to make the longitudinal joint. It is, for example, made of a plastic material, preferably obtained by injection molding. By way of materials, particular mention may be made of polyamide, polyethylene, SAN. As an alternative, the body may be made of metal.

The body 10 comprises a sealing element support part 11 and two wings 20 and 21 extending one on each side of the support part 11 in the same direction.

The wings 20 and 21 are of substantially parallelepipedal shape. They each have two opposite longitudinal faces 22 and 23 and two opposite lateral walls 24 and 25 running along the longest length of a wing and connecting to the longitudinal faces 22 and 23.

The wing connecting part 11 is for example of substantially parallelepipedal shape. It has two opposite thrust faces 12 and 13 which are connected to the connection wings, two opposite faces 14 and 15 which are parallel and situated on the same side as the longitudinal faces 22 and 23 respectively of the wings, and two opposite lateral faces 16 and 17 which are parallel and situated on the same side as the lateral walls 24 and 25 respectively of the wings.

The faces 14 and 15 of the part 11 project from the longitudinal faces 22 and 23 of the wings; and likewise, the lateral faces 16 and 17 project from the lateral walls 24 and 25 of the wings. Thus, the wings extend one on each side of the support part, being connected to the two opposite faces 12 and 13 of the part 11 over part of its height and at some distance from the edges of the faces, the wings facing the protrusions of the sealing element.

Finally, each of the wings 20 and 21 has a retaining system 26 projecting from each lateral wall 24 and 25, this system being intended to hold the connector immobilized in position once it has been engaged in the hollow section-piece ends. This retaining system is, by way of example, a metal pin arranged in the thickness of the wing and passing right through the lateral walls 24 and 25.

The sealing element 3 is made of a polymer material impervious to water, gas and water vapor. It is arranged on the support part 11 of the body 10, by being secured at least to the face 14.

The material of which the sealing element is made has a hardness ranging between 20 and 60 Shore A.

A material such as this is, for example, an elastomer, for example of the styrene-ethylene-butylene-styrene (SEBS) type, or an injectable polyurethane (TPU), or an appropriate thermoplastic such as the material with the trade name VITAPRENE marketed by VTC.

The sealing element has a substantially flat shape in the manner of a pellet. Its height does not exceed 1 mm, and is preferably of the order of 0.5 mm.

It covers, in part 30, the face 14 of the body 10 and advantageously drops, at 30a, onto an edge portion of the lateral faces 16 and 17. The sealing element also has opposite lateral protrusions 31 and 32 the widths of which are at least equal to the width of the side of the face 14 from which they extend.

The protrusions 31 and 32 extend toward the wings 20 and 21 of the body 10 respectively. Because the face 14 of the part 11 of the body projects with respect to the longitudinal faces 22 and 23 of the wings, the protrusions 31 and 32 of the sealing element facing the longitudinal faces of the wings thus form respectively two opposed accommodating spaces or grooves 40 and 41, one on each side of the part 11.

Furthermore, the protrusions 31 and 32 respectively have ends 33 and 34 substantially curved toward the wings of the body 10.

The sealing element 3 is secured to the face 14 of the body 10 by being attached by bonding or welding or overmolding with a mechanical or chemical bond, or alternatively by clip-fastening, with collaborating shapes (not illustrated here) of the part 11 of the body 10 and of the sealing element 3.

As an alternative, the sealing element 3 and the body 10 may be obtained as a single piece produced for example by molding using a two-shot injection molding technique, the bond between the two materials being either mechanical or chemical if these materials are compatible, such as a suitable polyamide and a suitable polyurethane.

The connector 1 of FIG. 1 is therefore used to connect two section-piece ends 5 in a lengthwise joint (FIG. 3). These section-piece ends may be made of stainless steel, aluminum, plastic, a combination of materials, or in fact any material suited to the end-use of the section piece.

Butting two section-piece ends together may serve for example to form a frame intended in particular for the manufacture of an insulating glazing unit. An insulating glazing unit as illustrated in FIG. 7 actually comprises at least two sheets of glass 60 and 61 separated in a sealed manner by an inserted frame 5a which is secured around its entire periphery to the internal face of the sheets of glass using butyl 63, gas 62 being trapped between the two sheets of glass. Sealing mastic is applied to the outside, between the two sheets of glass and the inserted frame.

The inserted frame is therefore manufactured using a section piece bent in its corners, and the two free ends of which are butted together along a side of the frame using a flat connector.

To make the glazing unit liquid-tight, gas-tight and to seal it against water vapor, the section piece has, at least on the face 50a intended to face the outside of the glazing unit, hereinafter termed the exterior face, and preferably also on part of the lateral faces in connection with the outer face, a suitable sealing coating such as aluminum, or alternatively said faces that are to be protected are made entirely of a suitable sealing material. For an interlayer frame section piece reference may be made to patent application EP 852 280.

Thus, the joint between the connector and the section-piece ends must also be sealed, at least on the exterior face 50a and preferably also over a part of the lateral faces that is not coated with butyl 63.

The connection using the connector 1 of the invention is performed as follows. Each hollow end 5 is fitted around a respective one of the wings 20 and 21 of the connector.

Each section-piece end 5 comprises two opposite walls 50 and 51 of which one, in this instance the wall 51, is intended to face the layer of gas of the insulating glazing unit. The walls 50 and 51 are connected in a closed manner by two opposite lateral walls 52 and 53 which are intended to be secured by butyl 63 to the internal faces of the sheets of glass.

The hollow section-piece end 5 is fitted over one of the wings 20 or 21 of the connector 1, and this is done forcibly because of the presence of the retaining system 26. The end 5 is pushed in until its free edge butts against one of the walls 12 or 13 respectively of the part 11 of the connector. Next, the hollow end of the second section piece is pushed in a similar way onto the other wing of the connector.

The walls of each section-piece end thus surround each wing of the connector. The external face 51a of the wall 51 of the section-piece end is level with the face 15 of the part 11 of the body of the connector so that when the section-piece ends 5 are both pushed onto the wings of the connector, the external faces 51a of the walls 51 of the section pieces and the face 15 of the connector form a flat surface.

The opposite wall 50 belonging to each section-piece end is housed in each of the grooves 40 and 41 of the connector, each of the protrusions 31 and 32 of the sealing element closely covering the external face 50a of the wall 50 with a preload exerted by virtue of the curved ends 33 and 34 of the protrusions. The material of which the ends of the protrusions are made is elastic enough for these ends to be deformed when the connector is forcibly fitted around the wings of the connector and against the part 11, while at the same time exerting enough force to keep the sealing element pressed firmly against the wall 50 of the section piece ends.

The sealing element 3 thus covers the joint between the ends of section piece at the part 11 of the connector. Only the wall 50 will be exposed to the external environment, its exterior face 50a therefore being sealed as already stated above; the sealing element is thus in this instance configured to closely cover the exterior face 50a of the wall 50 of the section-piece ends and thus ensures continuity of sealing at the joint. Advantageously, an edge portion of the opposite lateral walls 52 and 53 of the section-piece ends, which also has an impervious coating, is also covered with the sealing element, thus enhancing on the sides the continuity of the seal at the joint.

FIG. 4 illustrates a corner connector according to the invention intended to make a sealed corner joint as illustrated in FIG. 6 between two hollow section pieces 5a and 5b butted together at a corner.

The body 10 of the connector, just as with the flat connector, has two wings 20 and 21 which make an angle equivalent to the angle at which the section-piece ends 5 are to be connected (in this instance, an angle of)90°. The two wings meet at the part 11 of the body 10 positioned in the corner.

Just as with the flat connector, the wings of the body have the same features accompanied by the same references.

The wings, on the side of one of the longitudinal faces 23, are connected at the part 11 by forming a thrust projection 11a. On the opposite side, on the face 14 of the part 11 connecting the wings which project with respect to the longitudinal faces 22 of this angle, the part 11 receives the sealing element 3.

The sealing element 3 has opposite lateral protrusions 31 and 32 extending toward the wings and having a width greater than that of the wings, adapted at least to the width of the wall 50 of the section-piece end. The protrusions 31 and 32 which face the longitudinal faces 22 of the wings 20 and 21 respectively form respective grooves 40 and 41.

Just like with the flat connector, the sealing element 3 is attached by securing it against the face 14 of the part 11 or is obtained directly in combination with the body 10 by a suitable manufacturing process such as a two-shot injection molding technique.

Butting two section-piece 5a and 5b ends 5 together can also be used to form a frame of an insulating glazing unit, the section pieces which correspond to the sides of the frame being connected at the corners of the frame using such a corner connector.

Connection using the corner connector 1 of the invention is performed as follows. Each hollow end 5 is fitted around a respective one of the wings 20 and 21 of the connector, and this is done forcibly because of the presence of the retaining systems 26.

The end 5 is pushed in until its free end comes into abutment against the wall 12, or respectively 13, of the part 11 of the connector.

The wall 51 of each section-piece end that is intended to face the layer of gas butts against the projection 11a so that the external face 51a of the walls 51 of the section pieces and the angular projection 11a are perfectly square.

The wall 50 of each section-piece end butts against each respective groove 40 and 41; the respective protrusions 31 and 32 closely cover the external face 50a of said walls, with a preload exerted by the curved ends 33 or 34 of the protrusions. Advantageously, the end portion of the lateral walls 52 and 53 of the section pieces connected to the face 50 is also covered with the sealing element 3 so as to completely seal that face of the joint between the section pieces which faces the outside.

In the exemplary embodiments described hereinabove, the body of the connector comprises two wings extending one on each side of the sealing element support part 11, the two wings allowing easy collaboration with the hollow section-piece ends. Nonetheless, it is also possible to conceive of a part 11 alone, the body 10 and the sealing element 3 forming a kind of “mushroom”, the free edges of the ends of the section pieces collaborating with the thrust faces 12 and 13 of the part 11, a connection can be made by bonding, and the sealing element covering the exterior face of one of the walls of the section-piece ends.

1. A connector intended to connect two hollow section-piece ends, comprising a body and a sealing element which is impervious to liquids, gases and water vapor and which is supported by a part of the body, the sealing element comprises two opposed protrusions which project laterally with respect to the sealing element support part so as to form, between these protrusions and the body, respectively, two accommodating spaces, wherein the protrusions of the sealing element have respective ends which are inclined in the same direction.

2. The connector as claimed in claim 1, wherein the ends of the protrusions are curved toward the body of the connector.

3. The connector as claimed in claim 1, wherein the body and the sealing element are made of two separate materials or of the same material.

4. The connector as claimed in claim 1, wherein the protrusions are made of an elastic material.

5. The connector as claimed in claim 1, wherein the sealing element is made of a plastic material with a hardness ranging between 20 and 60 Shore A.

6. The connector as claimed in claim 1, wherein the material of the sealing element is an elastomer of the styrene-ethylene-butylene-styrene (SEBS) type, or a thermoplastic injectable polyurethane (TPU), or alternatively an EPUM.

7. The connector as claimed in claim 1, wherein the sealing element covers at least one face of the support part and falls onto an edge portion of the lateral faces of said support part.

8. The connector as claimed in claim 1, wherein the sealing element does not exceed 1 mm in height.

9. The connector as claimed in claim 1, wherein the body is essentially longitudinal and comprises two wings one extending on each side of the support part, these being connected to two opposite faces of the part over part of its height and at some distance from the edges of the faces, the wings facing the protrusions of the sealing element.

10. The connector as claimed in claim 1, wherein the body comprises two wings one extending on each side of the support part at angles, these being connected to two opposite faces of the part over part of its height and at some distance from the edges of the faces, the wings facing the protrusions of the sealing element.

11. The connector as claimed in claim 1, wherein the body is made as a single piece.

12. The connector as claimed in claim 1, wherein the body is based on a plastic material or is made of metal.

13. The connector as claimed in claim 1, wherein the body and the sealing element are obtained by molding.

14. The connector as claimed in claim 1, wherein the sealing element is attached to the support part of the body by clip-fastening, bonding, welding, or overmolding.

15. The connector as claimed in claim 1, wherein the sealing element and the body are obtained by molding using a two-shot injection molding technique.

16. The connector as claimed in claim 9, wherein each wing of the body has, projecting from its lateral walls, a retaining system comprising a metal or plastic pin passing right through the wing.

17. An assembly formed of at least two hollow section-piece ends and of at least one connector as claimed in claim 1 and connecting said section-piece ends, each of the accommodating spaces of the connector housing the wall of a respective section-piece end, and the sealing element having its lateral protrusions pressed against the external face of each of said walls of the section-piece ends thereby exerting a preload via the inclined ends of the protrusions, the two hollow ends collaborating with the body of the connector and coming in abutment against the two opposite faces of the support part, respectively.

18. The assembly as claimed in claim 17, wherein the lateral protrusions of the sealing element fall onto an edge portion of the external face of the lateral walls of the section-piece ends.

19. The assembly as claimed in claim 17, wherein the body of the connector is provided with two wings extending two opposite faces of the support part, the two wings being inserted one into the two hollow section-piece ends, respectively.

20. The assembly as claimed in claim 19, wherein the wings are provided with retaining systems which hold the hollow section-piece ends in place on the body of the connector.

21. A frame consisting of at least one assembly as claimed in claim 17.

22. An insulating glazing unit comprising at least one frame as claimed in claim 21, the sealing element ensuring the continuity of the seal at the joint with the hollow section-piece ends, the face of the section piece or section pieces that form(s) the frame and is covered at the section-piece ends with the protrusions of the scaling element being sealed against liquids, gases and water vapor.

23. A method of connecting two hollow ends of section piece using a connector as claimed in claim 9, wherein the connector is forcibly inserted, via one of its wings, into the hollow part of one of the ends of section piece, while the second section-piece end is fitted around the free opposite wing of the connector, also by establishing a pushing force until the two section-piece ends butt against the sealing element support part, the scaling element covering the joint between the section piece ends, at least on the face intended to face the external environment, with a preload exerted by the inclined ends of the sealing element.
